(19) United States
(12) Patent Application Publication
(10) Pub. No.: US 2015/0042221 A1
(43) Pub. Date: Feb. 12, 2015

(54) SUPPORT STRUCTURE FOR DRAWER UNIT FOR USE WITH COMBINATION DOMESTIC APPLIANCES

(71) Applicant: BSH Home Appliances Corporation, Irvine, CA (US)

(72) Inventor: Michael Penuel, Swansboro, NC (US)

(73) Assignee: BSH Home Appliances Corporation, Irvine, CA (US)

(21) Appl. No.: 13/964,189

(22) Filed: Aug. 12, 2013

(51) Int. Cl. A47B 81/00; A47B 88/00; A47J 39/00; A47B 88/04

(52) U.S. Cl. CPC A47B 81/00; A47B 88/04; A47B 88/0044; A47J 39/00
USPC 312/236; 312/348.4

(57) ABSTRACT

A modular appliance combination unit is provided that has a drawer unit and an upper appliance. The drawer unit has two transverse support bars having first ends resting on a structural vertical wall and second ends resting on another structural vertical wall such that the transverse support bars bridge a space occupied by the drawer when the drawer is in a closed position. A pair of universal connector brackets connect the upper appliance to the drawer unit. The transverses support bars support the weight of the upper appliance and have different attachment locations to which the universal connector brackets can be attached such that upper appliances of different widths can be accommodated.

### FIELD OF THE INVENTION

The invention is directed to a drawer unit for use with a domestic appliance. More particularly, the invention is directed to the support structure of a drawer unit to provide a high quality drawer unit that can be used below a multitude of different domestic appliances in various combinations.

An example of an application for the invention is a warmer/storage drawer unit for use under domestic appliances having bodies of different widths.

### BACKGROUND OF THE INVENTION

In some modern kitchens, stacked, built-in, appliances are used to conserve space and to provide an aesthetically pleasing look. Such appliances can include, for example, conventional ovens, microwave ovens, steam ovens, warming drawers and storage drawers. Although appliances stacked on top of each other generally have a uniform width at the face of the appliances, the widths of the bodies (that portion of the appliance that is recessed into the cabinet or wall) of the appliances can differ.

In these stacked combinations, the weight of an upper appliance is sometimes supported by the appliances below it. In the case of an upper appliance stacked on a lower appliance where both appliances have the same body width, it is relatively easy to transfer the weight of the upper appliance through the side walls of the lower appliance and to the ground. However, when the upper appliance has a body width that is less than the body width of the lower appliance, provision needs to be made in the lower appliance to transfer the weight of the upper appliance in such a way that the lower appliance is not deformed. This is particularly the case when the lower appliance is a drawer unit having a drawer that spans a large portion of the width of the lower appliance and, therefore, the weight of the upper appliance must be transferred to the outside structure of the drawer unit. This weight transfer is further complicated by the need to allow for upper appliances having different body widths.

In addition to the above described needs it is preferable, to reduce the cost and complexity of manufacture, to provide one support structure that can accommodate upper appliances of multiple different body widths.

It is desirable to reduce the complexity of products assembled in the factory by providing a modular design concept. This involves the individual products being offered to the consumer as a freestanding individual unit or as a combination unit which can be installed side-by-side and assembled at the point of use and not in the product factory. This approach requires the side-by-side units to maintain alignment vertically and also to make maintain the gaps between the side-by-side units. That is to say, the control panels, doors and top and bottom of the two units must maintain the same gaps between features of each appliance. Modular units may be a warming or storage drawer to be connected to another appliance such as a microwave or steam oven installed next to a built-in cooking oven. The gaps between the control panels, doors and top and bottom heights must be maintained consistently throughout the life of the appliances. With the design of the single built in appliance to replace most common in-use appliance sets, there is a need to design a warming drawer and storage drawer of sufficient size to maintain the required gaps when installed as a standalone unit or a combination application. It is desirable for the warming drawer or storage drawer to be capable of being used as a stand-alone unit or in a combination application without having to add additional parts for support of the additional appliance to create the combination unit. Warming drawers and storage drawers by nature of their use are of simple construction and often the simple construction of the drawer cannot support the weight of the additional appliance, such as a microwave oven or steam oven, in a combination application. The varying widths of the microwave oven and the steam oven also cause additional support to be required to use a common warming drawer storage drawer for all offered applications.

In light of the above, there is a need for a universal support structure for a drawer unit that can properly transfer the weight of upper appliances having varying widths such that the weight of the upper appliances is transferred around the drawer area of the drawer unit.

### SUMMARY

The invention achieves the benefit of providing a universal support structure for a drawer unit that can properly transfer the weight of upper appliances having varying widths such that the weight of the upper appliance is transferred around the drawer area of the drawer unit.

This benefit is achieved by providing transverse support bars in the upper area of the drawer unit such that the weight of the upper appliance is transferred through the transverse support bars to vertical structural walls located outside of the drawer area of the drawer unit.

Particular embodiments of the invention are directed to a modular, multi-piece, domestic appliance combination unit having a combination unit overall face width at a front face of the combination unit. The combination unit includes a drawer unit having a drawer unit overall face width at a front face of the drawer unit equal to the combination overall face width, the drawer unit having a drawer movable in an opening direction between a closed position and an open position, two outside vertical walls positioned along lateral sides of the drawer unit, the outside vertical walls being parallel to the opening direction, two structural vertical walls, each of structural vertical walls being positioned between one of the outside vertical walls and the drawer, and a first transverse support bar having a first end and a second end, the first end resting on one of the structural vertical walls and the second end resting on the other of the structural vertical walls such that the first transverse support bar bridges a space occupied by the drawer when the drawer is in the closed position; an upper appliance mounted to a top of the drawer unit, the upper appliance having a front face having an upper appliance overall face width equal to the combination overall face width, and a body having a body width in a direction parallel to the upper appliance overall face width, the body width being less than the upper appliance overall face width; and a first universal connector bracket connecting the upper appliance to the drawer unit, the first universal connector bracket having an upper appliance attachment flange having an upper appliance attachment feature that attaches the first universal connector bracket to the upper appliance, and a drawer unit attachment flange having a drawer unit attachment feature that attaches the first universal connector bracket to the drawer unit. The drawer unit has a first plurality of attachment locations to which the first universal connector bracket can be attached, a first one of the first plurality of attachment locations corresponding to the body width of the upper appliance.

Other embodiments of the invention are directed to a drawer unit configured for use as part of a modular, multi-piece, domestic appliance combination unit having a combination unit overall face width at a front face of the combination unit. The combination unit has an upper appliance mounted to a top of the drawer unit, the upper appliance having a front face having an upper appliance overall face width equal to the combination overall face width, and a body having a body width in a direction parallel to the upper appliance overall face width, the body width being less than the upper appliance overall face width, the combination unit also has a first universal connector bracket connecting the upper appliance to the drawer unit, the first universal connector bracket having an upper appliance attachment flange having an upper appliance attachment feature that attaches the first universal connector bracket to the upper appliance, and a drawer unit attachment flange having a drawer unit attachment feature that attaches the first universal connector bracket to the drawer unit. The drawer unit includes a drawer movable in an opening direction between a closed position and an open position; two outside vertical walls positioned along lateral sides of the drawer unit, the outside vertical walls being parallel to the opening direction; two structural vertical walls, each of structural vertical walls being positioned between one of the outside vertical walls and the drawer; and a first transverse support bar having a first end and a second end, the first end resting on one of the structural vertical walls and the second end resting on the other of the structural vertical walls such that the first transverse support bar bridges a space occupied by the drawer when the drawer is in the closed position. The drawer unit has a drawer unit overall face width at a front face of the drawer unit equal to the combination overall face width, the drawer unit has a first plurality of attachment locations adapted to be attached to the first universal connector bracket, a first one of the first plurality of attachment locations corresponding to the body width of the upper appliance.

### BRIEF DESCRIPTION OF THE DRAWINGS

The following figures form part of the present specification and are included to further demonstrate certain aspects of the disclosed features and functions, and should not be used to limit or define the disclosed features and functions. Consequently, a more complete understanding of the exemplary embodiments and further features and advantages thereof may be acquired by referring to the following description taken in conjunction with the accompanying drawings, wherein:

FIG. 1 shows several examples of particular embodiments of the invention;

FIG. 2 is a perspective view of an example of an embodiment of the invention;

FIG. 3 is a side view of the embodiment shown in FIG. 2;

FIG. 4 is a perspective view of an example of an embodiment of the invention;

FIG. 5 is a side view of the embodiment shown in FIG. 4;

FIG. 6 is a perspective view of a bracket in accordance with the invention shown in a first position;

FIG. 7 is a perspective view of a bracket in accordance with the invention shown in a second position;

FIG. 8 is a perspective view of an example of an embodiment of the invention;

FIG. 9 is a perspective view of the embodiment shown in FIG. 8;

FIG. 10 is a perspective view of an example of an embodiment of the invention; and

FIG. 11 is perspective view of the embodiment shown in FIG. 10.

### DETAILED DESCRIPTION

The invention is described herein with reference to the accompanying drawings in which exemplary embodiments of the invention are shown. The invention may, however, be embodied in many different forms and should not be construed as limited to the embodiments set forth herein.

As explained above, embodiments of the invention provide a universal support structure for a drawer unit that can properly transfer the weight of upper appliances having varying widths such that the weight of the upper appliance is transferred around the drawer area of the drawer unit.

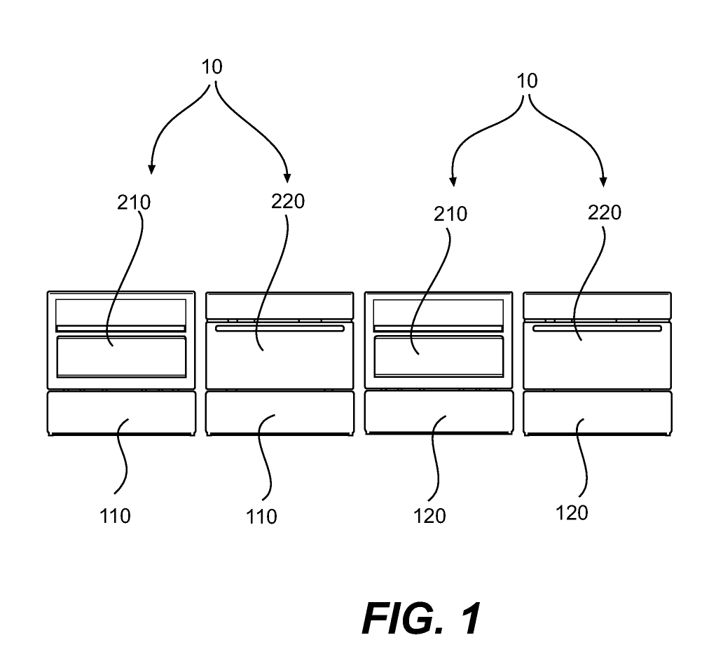

FIG. 1 shows four examples of possible combination units 10 that have a drawer unit and an appliance mounted above the drawer unit. These examples include a microwave oven 210 above a warming drawer unit 110, a steam oven 220 above warming drawer unit 110, microwave oven 210 above a storage drawer unit 120, and steam oven 210 above storage drawer unit 120. Although four examples are shown here, many other combination units are possible. As can be seen in FIG. 1, the front face widths of warming drawer unit 110, storage drawer unit 120, microwave oven 210, and steam oven 220 are uniform.

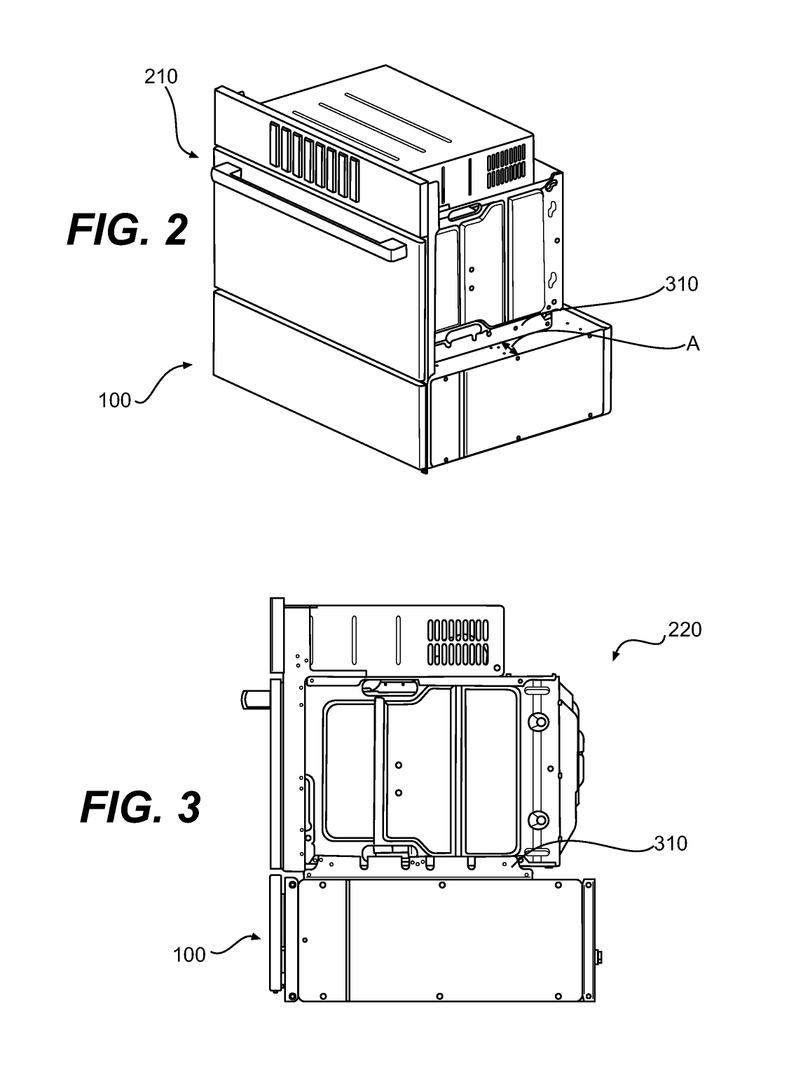

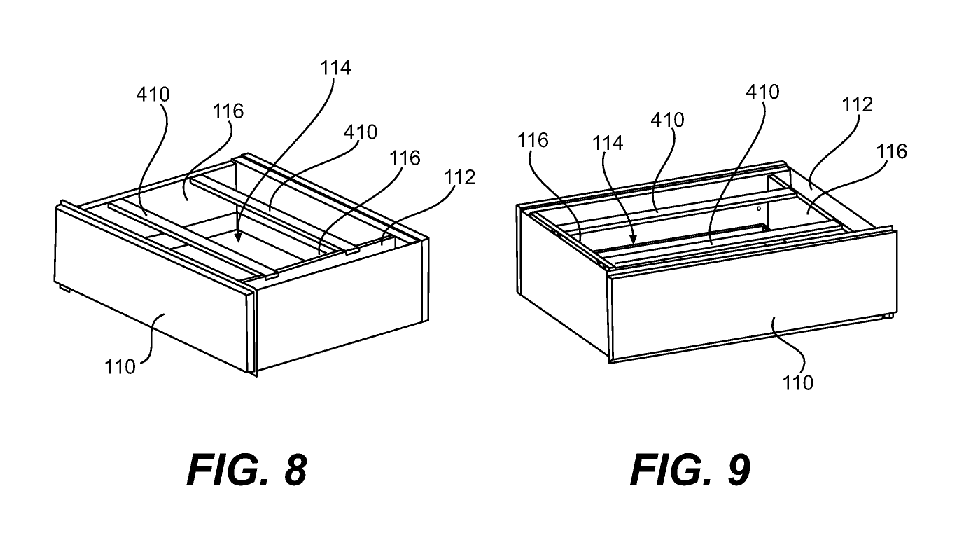

FIGS. 2 and 3 show in more detail steam oven 220 mounted on top of a warming/storage drawer unit 100. In some instances where either warming drawer unit 110 or storage drawer unit 120 can be used, the generic reference number 100 will be used to represent a drawer unit. As can be seen in FIG. 2, the width of the body of steam oven 220 is less than the front face width of steam oven 220. This can present a problem in properly transferring the weight of steam oven 220 through drawer unit 100 without deforming drawer unit 100. A drawer unit such as drawer unit 100, as shown in more detail in FIGS. 8-11, can have a large open area in which the drawer of drawer unit 100 is positioned. This large open area presents a problem for transferring the weight of an appliance positioned above drawer unit 100 without deforming drawer unit 100 and possibly interfering with the proper function of the drawer.

In the example shown in FIGS. 2 and 3, the body side wall of steam oven 220 is offset a distance “A” from the exterior side wall of drawer unit 100. Although not necessarily the case, in this example the opposite body side wall of steam oven 220 is also offset distance “A” from the opposite exterior side wall of drawer unit 100. As a result, in this example the body of steam oven 220 is centered over drawer unit 100. However, in other examples the body of steam oven 220 can be offset to one side or the other. As can be seen in FIGS. 2 and 3, steam oven 220 is attached to the top plate of drawer unit 100 by a universal connector bracket 310 (shown in more detail in FIG. 7).

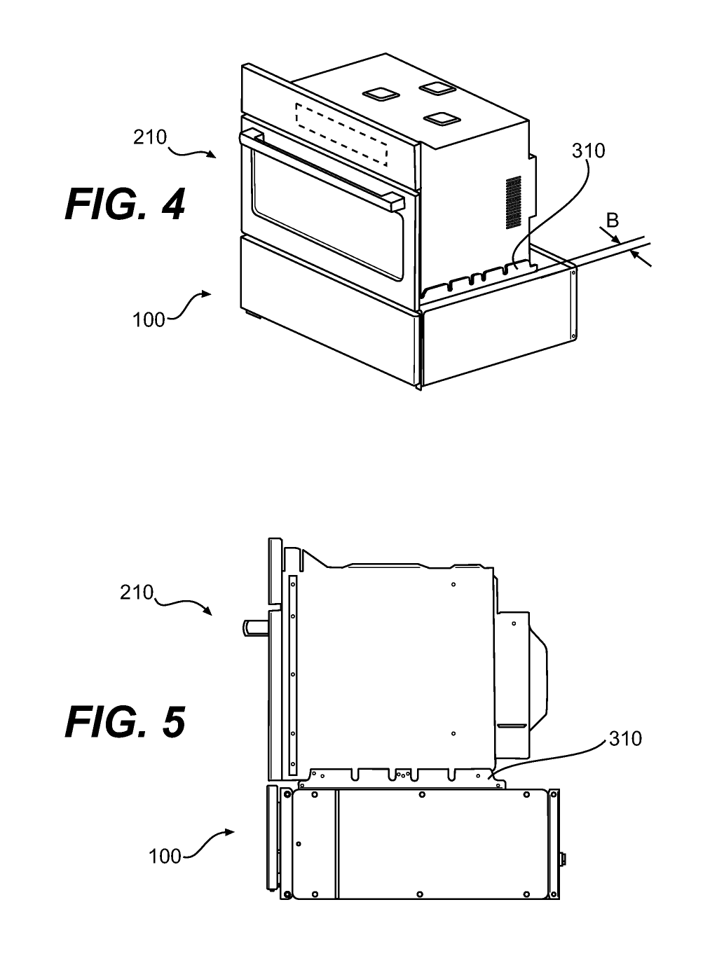

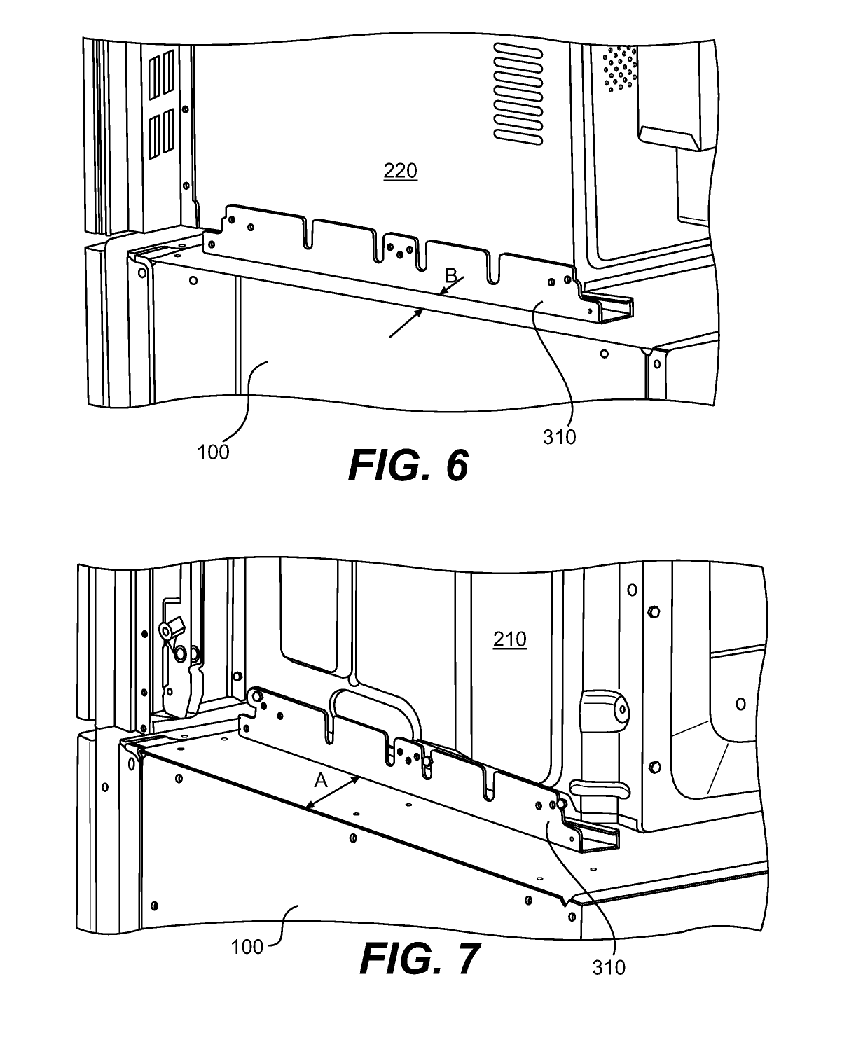

FIGS. 4 and 5 are similar the FIGS. 2 and 3, but show microwave oven 210 instead of steam oven 220 above drawer unit 100. In this example, the body of microwave oven 210 is wider than the body of steam oven 220. As a result, a distance “B” shown in FIG. 4 is less than distance “A” shown in FIG. 2 (shown in more detail in FIGS. 6 and 7). Due to these different distances, there is a need for universal connector bracket 310 to be attachable to the top plate of drawer unit 100 in different locations depending on whether microwave oven 210 or steam oven 220 (or some other appliance having yet a different with) is attached to drawer unit 100. This need is satisfied by the structure of drawer unit 100, shown in detail in FIGS. 8-11.

FIGS. 8 and 9 show warming drawer unit 110 as having two vertical side support walls 116 that are either side of a drawer 114 and provide structural support for warming drawer unit 110. Two transverse support bars 410 span the area occupied by drawer 114 and are supported at their ends by vertical side support walls 116. In this example, an area 112 is provided outside of one of the vertical side support walls 116 to house, for example, a heater and/or control devices for providing the warming feature of warming drawer unit 110. As discussed above, in combination units having an appliance, such as, for example, microwave oven 210 or steam oven 220, located above warming drawer unit 110 it is necessary to provide sufficient support for the weight of the upper appliance. By providing transverse support bars 410 having sufficient strength to support the upper appliance, the weight of the upper appliance can be transferred through transverse support bars 410 to vertical side support walls 116 and, in turn, to whatever support platform exists below warming drawer unit 110 without deforming warming drawer unit 110. This structure also permits, in some embodiments, the use of a thin, nonstructural, top plate of warming drawer unit 110 because the top plate does not have to support the weight of the upper appliance.

Because, as described above, warming drawer unit 110 can be used below various different upper appliances having different body widths, the warming drawer (for example the top plate of the warming drawer) has multiple attachment points to which universal connector bracket 310 can be attached. Two examples of such attachment points are shown in FIGS. 6 and 7.

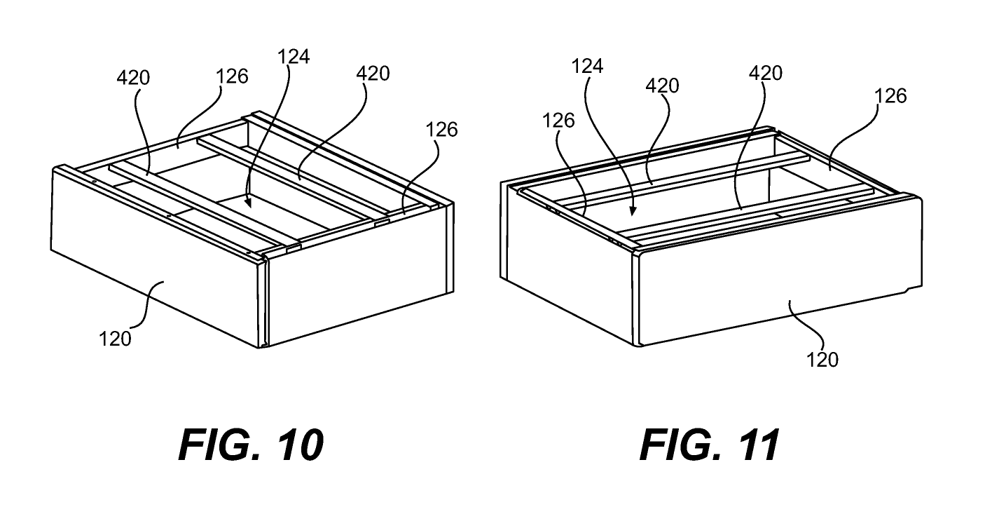

FIGS. 10 and 11 are similar to FIGS. 8 and 9, but show storage drawer unit 120, instead of warming drawer unit 110. In this example, storage drawer unit 120 has two vertical side support walls 126 that are either side of a drawer 124 and provide structural support for storage drawer unit 120. Two transverse support bars 420 span the area occupied by drawer 124 and are supported at their ends by vertical side support walls 126. In this example, no area similar to area 112 of warming drawer unit 110 is provided because no heater and/or control devices are needed. As discussed above, in combination units having an appliance, such as, for example, microwave oven 210 or steam oven 220, located above storage drawer unit 120 it is necessary to provide sufficient support for the weight of the upper appliance. By providing transverse support bars 420 having sufficient strength to support the upper appliance, the weight of the upper appliance can be transferred through transverse support bars 420 to vertical side support walls 126 and, in turn, to whatever support platform exists below storage drawer unit 120 without deforming storage drawer unit 120. This structure also permits, in some embodiments, the use of a thin, nonstructural, top plate of storage drawer unit 120 because the top plate does not have to support the weight of the upper appliance.

The storage drawer has a plurality of attachment points. For example, one set of attachment points correspond to the position of universal connector brackets 310 that properly position steam oven 220 on top of drawer unit 100. Another set of attachment points correspond to the position of universal connector brackets 310 that properly position microwave oven 210 on top of drawer unit 100. In addition, other attachment points can be provided for other body widths that correspond to other upper appliances.

The examples of transverse support bars 410, 420 shown in FIGS. 8-11 are C-channel shaped. The embodiments provide two horizontal tabs on one end of the transverse support bar which slip into mating receiver slots on one of the vertical side support walls, and a vertical tab at the other end of the transverse support bar which is inserted into a mating slot on the top of the opposite vertical side support wall.

By providing the structure described above, a universal attachment and support system is provided that can be easily assembled at the point of installation of the appliance combination unit regardless of which upper appliance is being attached to which drawer unit. This allows the upper appliance and the drawer unit to be packaged and shipped separately, which eliminates the need for a combination unit to be shipped assembled. This has several advantages including reducing the weight of each box shipped and reducing the number of different combination units to be assembled at the manufacturing plant.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the invention.

What is claimed is:

1. A modular, multi-piece, domestic appliance combination unit having a combination unit overall face width at a front face of the combination unit, the combination unit comprising:
a drawer unit having a drawer unit overall face width at a front face of the drawer unit equal to the combination overall face width, the drawer unit having
a drawer movable in an opening direction between a closed position and an open position,
two outside vertical walls positioned along lateral sides of the drawer unit, the outside vertical walls being parallel to the opening direction,
two structural vertical walls, each of structural vertical walls being positioned between one of the outside vertical walls and the drawer, and
a first transverse support bar having a first end and a second end, the first end resting on one of the structural vertical walls and the second end resting on the other of the structural vertical walls such that the first transverse support bar bridges a space occupied by the drawer when the drawer is in the closed position;
an upper appliance mounted to a top of the drawer unit, the upper appliance having
a front face having an upper appliance overall face width equal to the combination overall face width, and
a body having a body width in a direction parallel to the upper appliance overall face width, the body width being less than the upper appliance overall face width; and
a first universal connector bracket connecting the upper appliance to the drawer unit, the first universal connector bracket having
an upper appliance attachment flange having an upper appliance attachment feature that attaches the first universal connector bracket to the upper appliance, and
a drawer unit attachment flange having a drawer unit attachment feature that attaches the first universal connector bracket to the drawer unit,
wherein the drawer unit has a first plurality of attachment locations to which the first universal connector bracket can be attached, a first one of the first plurality of attachment locations corresponding to the body width of the upper appliance.

2. The unit of claim 1, wherein the structural vertical walls are parallel to the outside vertical walls.

3. The unit of claim 1, wherein a second one of the first plurality of attachment locations corresponds to an alternate appliance having a body width that is different than the body width of the upper appliance.

4. The unit of claim 3, further comprising a second universal connector bracket that is identical to the first universal connector bracket,
wherein the drawer unit has a second plurality of attachment locations to which the second universal connector bracket can be attached, a first one of the second plurality of attachment locations corresponding to the body width of the upper appliance, and
a second one of the second plurality of attachment locations corresponds to the body width of the alternate appliance.

5. The unit of claim 4, further comprising a second transverse support bar identical to the first transverse support bar, the second transverse support bar having a first end and a second end, the first end resting on one of the structural vertical walls and the second end resting on the other of the structural vertical walls such that the second transverse support bar bridges the space occupied by the drawer when the drawer is in the closed position,
wherein the drawer unit has a third plurality of attachment locations to which the first universal connector bracket can be attached, a first one of the third plurality of attachment locations corresponding to the body width of the upper appliance.

6. The unit of claim 5, wherein the drawer unit has a fourth plurality of attachment locations to which the second universal connector bracket can be attached,
a first one of the fourth plurality of attachment locations corresponds to the body width of the upper appliance, and
a second one of the fourth plurality of attachment locations corresponds to the body width of the alternate appliance.

7. The unit of claim 4, wherein the drawer unit is a warming drawer unit.

8. The unit of claim 4, wherein the drawer unit is a storage drawer unit.

9. The unit of claim 6, wherein the drawer unit further comprises a top panel that rests on a top of the first transverse support bar and a top of the second transverse support bar such that a weight of the upper appliance is transferred to the first and second transverse support bars through the top panel.

10. A drawer unit configured for use as part of a modular, multi-piece, domestic appliance combination unit having a combination unit overall face width at a front face of the combination unit, the combination unit having an upper appliance mounted to a top of the drawer unit, the upper appliance having a front face having an upper appliance overall face width equal to the combination overall face width, and a body having a body width in a direction parallel to the upper appliance overall face width, the body width being less than the upper appliance overall face width, the combination unit also having a first universal connector bracket connecting the upper appliance to the drawer unit, the first universal connector bracket having an upper appliance attachment flange having an upper appliance attachment feature that attaches the first universal connector bracket to the upper appliance, and a drawer unit attachment flange having a drawer unit attachment feature that attaches the first universal connector bracket to the drawer unit, the drawer unit comprising:
a drawer movable in an opening direction between a closed position and an open position;
two outside vertical walls positioned along lateral sides of the drawer unit, the outside vertical walls being parallel to the opening direction;
two structural vertical walls, each of structural vertical walls being positioned between one of the outside vertical walls and the drawer; and
a first transverse support bar having a first end and a second end, the first end resting on one of the structural vertical walls and the second end resting on the other of the structural vertical walls such that the first transverse support bar bridges a space occupied by the drawer when the drawer is in the closed position,
wherein the drawer unit has a drawer unit overall face width at a front face of the drawer unit equal to the combination overall face width,
the drawer unit has a first plurality of attachment locations adapted to be attached to the first universal connector bracket, a first one of the first plurality of attachment locations corresponding to the body width of the upper appliance.

11. The drawer unit of claim 10, wherein the structural vertical walls are parallel to the outside vertical walls.

12. The drawer unit of claim 10, wherein a second one of the first plurality of attachment locations corresponds to an alternate appliance having a body width that is different than the body width of the upper appliance.

13. The drawer unit of claim 12, wherein the drawer unit has a second plurality of attachment locations adapted to be attached to a second universal connector bracket that is identical to the first universal connector bracket, a first one of the second plurality of attachment locations corresponding to the body width of the upper appliance, and
a second one of the second plurality of attachment locations corresponds to the body width of the alternate appliance.

14. The drawer unit of claim 13, further comprising a second transverse support bar identical to the first transverse support bar, the second transverse support bar having a first end and a second end, the first end resting on one of the structural vertical walls and the second end resting on the other of the structural vertical walls such that the second transverse support bar bridges the space occupied by the drawer when the drawer is in the closed position,
wherein the drawer unit has a third plurality of attachment locations adapted to be attached to the first universal connector bracket, a first one of the third plurality of attachment locations corresponding to the body width of the upper appliance.

15. The drawer unit of claim 14, wherein the drawer unit has a fourth plurality of attachment locations adapted to be attached to the second universal connector bracket,
a first one of the fourth plurality of attachment locations corresponds to the body width of the upper appliance, and
a second one of the fourth plurality of attachment locations corresponds to the body width of the alternate appliance.

16. The drawer unit of claim 13, wherein the drawer unit is a warming drawer unit.

17. The drawer unit of claim 13, wherein the drawer unit is a storage drawer unit.

18. The drawer unit of claim 15, wherein the drawer unit further comprises a top panel that rests on a top of the first transverse support bar and a top of the second transverse support bar such that a weight of the upper appliance is transferred to the first and second transverse support bars through the top panel.
